(19) United States
(12) Patent Application Publication
(10) Pub. No.: US 2020/0272230 A1
(43) Pub. Date: Aug. 27, 2020

(54) METHOD AND DEVICE FOR DETERMINING GAZE POINT BASED ON EYE MOVEMENT ANALYSIS DEVICE

(71) Applicant: BEIJING 7INVENSUN TECHNOLOGY CO., LTD., Beijing (CN)

(72) Inventor: Yunfei Wang, Beijing (CN)

(21) Appl. No.: 16/349,817

(22) PCT Filed: Dec. 7, 2018
(86) PCT No.: PCT/CN2018/119881

§ 371 Date: May 14, 2019

(30) Foreign Application Priority Data
Dec. 29, 2017 (CN) 201711499453.3

(51) Int. Cl. G06F 3/01; G02B 27/00; G06K 9/00

(52) U.S. Cl. CPC G06F 3/013; G06K 9/00604; G06K 9/00617; G02B 27/0093

(57) ABSTRACT

Provided is a method and apparatus for determining a gaze point based on an eye movement analysis device. The method includes: acquiring data information about a first area of eyes and data information about a second area of the eyes; determining data about the gaze point according to the data information about the first area and the second area, where the data about the gaze point includes: a preset gaze point, information about the gaze point corresponding to the first area and information about the gaze point corresponding to the second area sending the data about the gaze point to a terminal; and receiving, by the terminal, the data about the gaze point and determining information about position of the preset gaze point on a display screen according to the data about the gaze point.

The present application claims priority to a Chinese patent application No. 201810064311.2 entitled “METHOD AND APPARATUS FOR DETERMINING PUPIL POSITION” and filed on Dec. 29, 2017 to the CNIPA, the disclosure of which is incorporated in the present application by reference in its entirety.

### TECHNICAL FIELD

The present disclosure relates to the field of gaze tracking and, in particular, to a method and apparatus for determining a gaze point based on an eye movement analysis device.

### BACKGROUND

With the rapid development of science and technology, the virtual reality (VR) technology has been widely developed in various industries, for example, the popularity of 3D movies and 3D games. Therefore, the gaze tracking technology has also gained further development.

People need to wear 3D glasses or other devices when watching 3D movies or playing 3D games. However, when a user wearing the 3D glasses is gazing at a certain place, the user cannot clearly see a picture or an image on the screen due to parallax between the eyes, especially in the case of large parallax. Lines of sight of the user's eyes do not intersect at a point for a possible reason of focus conflicts or difference visions of the two eyes.

To solve the above problem, a gaze point interface is generally adopted in the existing art to accurately determine the gaze point of the eyes, thereby enabling the user to obtain a clear image. However, the existing gaze point interface only provides data about the gaze point of one eye or respectively provides data about the gaze point of the eyes, but when the lines of sight of the eyes do not intersect, the position of the gaze point on the screen cannot be accurately determined and the user has poor experience.

No effective solution has been provided to solve the problem that an eye movement analysis device cannot accurately acquire a position of the gaze point on the screen when the eyes have large parallax.

### SUMMARY

Embodiments of the present disclosure provides a method and apparatus for determining a gaze point based on eye movement analysis device to solve at the problem that an eye movement analysis device cannot accurately acquire a position of a gaze point on a screen when eyes have large parallax.

According to an aspect of the embodiments of the present disclosure, provided is a method for determining a gaze point based on eye movement analysis device. The method includes: acquiring data information about a first area of eyes and data information about a second area of the eyes; determining data about the gaze point according to the data information about the first area and the data information about the second area, where the data about the gaze point includes: a preset gaze point, information about the gaze point corresponding to the first area and information about the gaze point corresponding to the second area sending the data about the gaze point to a terminal; and receiving, by the terminal, the data about the gaze point and determining information about a position of the preset gaze point on a display screen according to the data about the gaze point.

According to an aspect of the embodiments of the present disclosure, provided is a method for determining a gaze point based on eye movement analysis device. The method includes: acquiring data information about a first area of eyes and data information about a second area of the eyes; determining data about the gaze point according to the data information about the first area and the data information about the second area, where the data about the gaze point includes: a preset gaze point, information about the gaze point corresponding to the first area and information about the gaze point corresponding to the second area and sending the data about the gaze point to a terminal.

According to an aspect of the embodiments of the present disclosure, provided is a method for determining a gaze point based on eye movement analysis device. The method includes: receiving, by a terminal, data about the gaze point, where the data about the gaze point includes: a preset gaze point, information about the gaze point corresponding to a first area of eyes and information about the gaze point corresponding to a second area of the eyes; and determining information about a position of the preset gaze point on a display screen according to the data about the gaze point.

According to an aspect of the embodiments of the present disclosure, provided is an eye movement analysis device. The device includes a collection unit and a processing unit. The collection unit is configured to acquire data information about a first area of eyes and data information about a second area of the eyes; determining data about the gaze point according to the data information about the first area and the data information about the second area, and send the data about the gaze point. The data about the gaze point includes: a preset gaze point, information about the gaze point corresponding to the first area and information about the gaze point corresponding to the second area. The processing unit is connected to the collection unit and configured to receive the data about the gaze point and determine information about a position of the preset gaze point on a display screen according to the data about the gaze point by acquiring the preset gaze point in the data about the gaze point, acquiring information about the gaze point of an eye corresponding to the preset gaze point, and determining information about a position matched with the information about the gaze point on the display screen.

According to another aspect of the embodiments of the present disclosure, further provided is an apparatus for determining a gaze point based on eye movement analysis device. The apparatus includes at least one processor and at least one memory for storing a program unit. The program unit is executed by the at least one processor and the program unit includes a first acquisition module, a second acquisition module and a sending module. The first acquisition module is configured to acquire data information about a first area of eyes and data information about a second area of the eyes. The second acquisition module is configured to determine data about the gaze point according to the data information about the first area and the data information about the second area. The data about the gaze point includes: a preset gaze point, information about the gaze point corresponding to the first area and information about the gaze point corresponding to the second area. The sending module is configured to send the data about the gaze point to a terminal.

According to another aspect of the embodiments of the present disclosure, further provided is a storage medium. The storage medium includes stored programs which execute the method for determining the gaze point based on the eye movement analysis device.

According to another aspect of the embodiments of the present disclosure, further provided is a processor. The processor is configured to execute programs, which, when executed, execute the method for determining the gaze point based on the eye movement analysis device.

In the embodiments of the present disclosure, by performing data transmission with a gaze point interface, the data information about the first area of the eyes and the data information about the second area of the eyes are acquired, the data about the gaze point is determined according to the data information about the first area and of the data information about the second area and the data about the gaze point is sent to the terminal, where the data about the gaze point includes the preset gaze point, the information about the gaze point corresponding to the first area and the information about the gaze point corresponding to the second area. Since the information about the gaze point of the first area and the information about the gaze point of the second area are both stored in the data about the gaze point and the data about the gaze point is sent from an underlying program to an application program, compared with obtaining information about the gaze point of only one eye in the existing art, the present application may accurately determine the position of the gaze point on the screen according to the information about the gaze point of the two eyes. In addition, a recommended gaze point of the eyes may be determined according to the preset gaze point and a more accurate position of the gaze point of the eyes on the screen may be obtained according to the recommended gaze point so that the present disclosure achieves the purpose of accurately determining the position of the gaze point on the screen when the eyes have large parallax, thereby achieving the technical effect of ensuring the accuracy of the position of the gaze point on the screen and solving the problem that the eye movement analysis device cannot accurately acquire the position of the gaze point on the screen when the eyes have large parallax.

### BRIEF DESCRIPTION OF DRAWINGS

The drawings described herein are used to provide a further understanding of the present disclosure, and form a part of the present application. The exemplary embodiments and descriptions thereof in the present disclosure are used to explain the present disclosure, and do not limit the present disclosure in any improper way. In the drawings:

FIG. 1 is a flowchart of a method for determining a gaze point based on an eye movement analysis device according to an embodiment of the present disclosure;

FIG. 2 is a flowchart of an optional method for determining a gaze point based on an eye movement analysis device according to an embodiment of the present disclosure;

FIG. 3 is a flowchart of an optional method for determining a gaze point based on an eye movement analysis device according to an embodiment of the present disclosure;

FIG. 4 is a structural diagram of an eye movement analysis device according to an embodiment of the present disclosure;

FIG. 5 is a structural diagram of an apparatus for determining a gaze point based on an eye movement analysis device according to an embodiment of the present disclosure;

FIG. 6 is a flowchart of a method for determining a gaze point based on an eye movement analysis device according to an embodiment of the present disclosure; and

FIG. 7 is a flowchart of a method for determining a gaze point based on an eye movement analysis device according to an embodiment of the present disclosure.

### DETAILED DESCRIPTION

The solutions in embodiments of the present disclosure will be described clearly and completely in conjunction with the drawings in the embodiments of the present disclosure from which the solutions will be better understood by those skilled in the art. Apparently, the embodiments described below are part, not all, of the embodiments of the present disclosure. Based on the embodiments described herein, all other embodiments obtained by those skilled in the art on the premise that no creative work is done are within the scope of the present disclosure.

It is to be noted that the terms “first”, “second” and the like in the description, claims and drawings of the present disclosure are used to distinguish between similar objects and are not necessarily used to describe a particular order or sequence. It should be understood that the data used in this way is interchangeable where appropriate so that the embodiments of the present disclosure described herein may also be implemented in a sequence not illustrated or described herein. In addition, the terms “including”, “having” or any other variations thereof are intended to encompass a non-exclusive inclusion. For example, a process, method, system, product or device that includes a series of steps or units may include not only the expressly listed steps or units but also other steps or units that are not expressly listed or are inherent to such a process, method, system, product or device.

### Embodiment 1

According to the present embodiment, provided is a method embodiment for determining a gaze point based on an eye movement analysis device. It is to be noted that the steps illustrated in the flowcharts in the drawings may be performed by a computer system such as a group of computers capable of executing instructions, and although logical sequences are illustrated in the flowcharts, the illustrated or described steps may be performed in sequences different from those described herein in some cases.

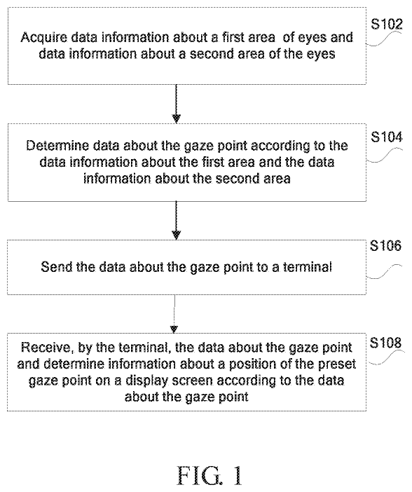

FIG. 1 is a flowchart of a method for determining a gaze point based on an eye movement analysis device according to an embodiment of the present disclosure. As shown in FIG. 1, the method includes steps described below.

In step S102, data information about a first area of eyes and data information about a second area of the eyes are acquired.

It is to be noted that the eye movement analysis device in the present application includes, but is not limited to, a VR device, an augmented reality (AR) device, a mixed reality (MR) device and a smart terminal capable of gaze tracking. For example, the smart terminal is a mobile phone, a computer, a wearable device (such as 3D glasses) or the like. The first area of the eyes may be a left eye or a right eye. When the first area is the left eye, the second area may be the right eye. When the first area is the right eye, the second area may be the left eye.

In addition, data information about the first area includes at least one of: image data of the first area, data collected by a sensor corresponding to the first area and a scan result of a raster scan performed on the first area and data information about the second area includes at least one of: image data of the second area, data collected by a sensor corresponding to the second area and a scan result of a raster scan performed on the second area. The data collected by the sensor includes, but is not limited to, stress data, a capacitance value or a capacitance variance, a voltage value or the capacitance variance, a heat amount and the like.

In addition, it is to be further noted that the method for determining the gaze point based on the eye movement analysis device is described below by using an example in which the first area is the left eye and the second area is the right eye.

In an optional embodiment, in the eye movement analysis device, cameras, that is, a left camera and a right camera, are respectively disposed in areas corresponding to the left eye and the right eye. The left camera may acquire an image of the left eye and the right camera may acquire an image of the right eye so that image data of the left eye and image data of the right eye are obtained. The image data of the left eye and the image data of the right eye may include, but are not limited to, a central position of a pupil, a size of the pupil, a shape of the pupil, a position of a spot projected on the eyes and the like.

In another optional embodiment, one or more capacitive elements are respectively disposed in the areas corresponding to the left eye and the right eye in the eye movement analysis device. The eye movement analysis device may collect the capacitance variance of the one or more capacitive components and obtain data information about the left eye and data information about the right eye respectively according to the capacitance variance. For example, if the capacitance value of the one or more capacitive elements corresponding to the left eye becomes larger and the variance of the capacitance value exceeds a preset threshold, it indicates that the pupil expands or shrinks. Since the capacitance value changes when the eye rotates, a rotational state of the eye may be determined according to the capacitance value.

In addition, it is to be further noted that the eye movement analysis device may also determine the data information about the left eye or the right eye according to the scan result of the raster scan and/or a change of a magnetic field. In addition, the eye movement analysis device may acquire the data information about the eyes by a combination of the preceding various methods for acquiring the data information about the eyes.

In step S104, data about the gaze point is determined according to the data information about the first area and the data information about the second area.

The data about the gaze point includes: a preset gaze point, information about the gaze point corresponding to the first area and information about the gaze point corresponding to the second area.

It is to be noted that when the first area is the left eye and the second area is the right eye, information about the gaze point of the left eye may be, but is not limited to, coordinates of a gaze point of the left eye, a gaze direction of the left eye, an angle between a line of sight of the left eye and a reference axis and the like; similarly, information about the gaze point of the right eye may be, but is not limited to, coordinates of a gaze point of the right eye, a gaze direction of the right eye, an angle between a line of sight of the right eye and the reference axis and the like. The preceding preset gaze point is a recommended gaze point. For example, when the preset gaze point is the gaze point corresponding to the left eye, a terminal determines the position of the gaze point on the screen by using the information about the gaze point of the left eye. The preceding terminal may be, but is not limited to, a device for data transmission, a device for data processing, a customer premise equipment for display and the like.

In addition, it is to be further noted that since the preset gaze point is an optimal gaze point obtained by comparing the information about the gaze point of the left eye with the information about the gaze point of the right eye, the position of the gaze point on the screen can be more accurately obtained by using the optimal gaze point.

In step S106, the data about the gaze point is sent to the terminal.

It is to be noted that the data information about the first area of the eyes and the data information about the second area of the eyes are processed by an underlying processor of the eye movement analysis device. After the data information about the first area of the eyes and the data information about the second area of the eyes are processed by the underlying processor, the data about the gaze point is sent to the terminal in manners such as a function call, a function callback, Transmission Control Protocol (TCP)/User Datagram Protocol (UDP) communications, a pipeline, memory processing and file processing. After receiving the data about the gaze point, the terminal processes the data about the gaze point and accurately determines information about a position of the gaze point on a display screen or display interface of the terminal. The information about such position may be, but is not limited to, coordinates, an angle and a vector of the preset gaze point on the display screen, coordinates, an angle and a vector of the preset gaze point in a virtual space or an actual space and the like.

In step S108, the terminal receives the data about the gaze point and determines the information about the position of the preset gaze point on the display screen according to the data about the gaze point.

It may be known based on the solution defined by the preceding steps S102 to S108 that by acquiring the data information about the first area of the eyes and the data information about the second area of the eyes, determining the data about the gaze point according to the data information about the first area and the data information about the second area and sending the data about the gaze point to the terminal, the terminal receives the data about the gaze point and determines the information about the position of the preset gaze point on the display screen according to the data about the gaze point, where the data about the gaze point includes the preset gaze point, the information about the gaze point corresponding to the first area and the gaze point corresponding to the second area.

It is easy to notice that the information about the gaze point of the first area and the information about the gaze point of the second area are both stored in the data about the gaze point and the data about the gaze point is sent from an underlying program to an application program, that is, the application program may acquire the information about the gaze point of the two eyes. Compared with obtaining information about the gaze point of only one eye in the existing art, the present application may accurately determine a position of the gaze point on a screen according to the information about the gaze point of the two eyes. In addition, the recommended gaze point of the eyes may be determined according to the preset gaze point, and a more accurate position of the gaze point of the eyes on the screen may be obtained according to the recommended gaze point, thereby further ensuring the accuracy of the position of the gaze point on the screen.

It may be known from the above description that the present application may achieve the purpose of accurately determining the position of the gaze point on the screen when the eyes have large parallax, thereby achieving the technical effect of ensuring the accuracy of the position of the gaze point on the screen and solving the problem that an eye movement analysis device cannot accurately acquire the position of the gaze point on the screen when the eyes have large parallax.

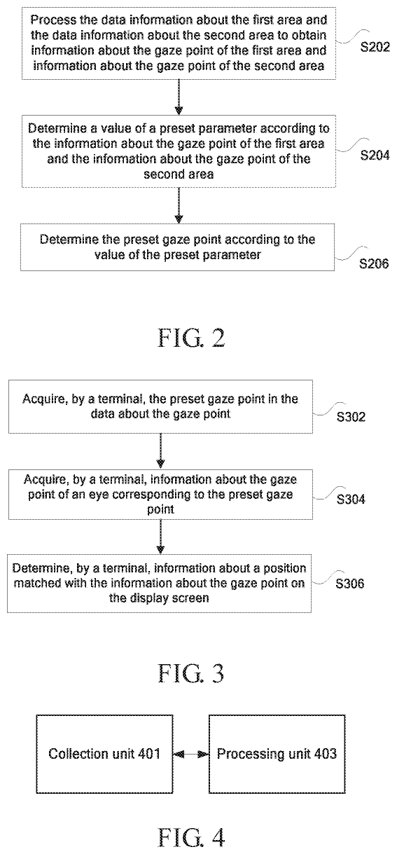

In an optional embodiment, FIG. 2 is a flowchart of an optional method for determining a gaze point based on an eye movement analysis device. As shown in FIG. 2, the data about the gaze point is determined according to the data information about the first area and the data information about the second area specifically through steps described below.

In step S202, the data information about the first area and the data information about the second area are processed to obtain the information about the gaze point of the first area and the information about the gaze point of the second area.

In step S204, a value of a preset parameter is determined according to the information about the gaze point of the first area and the information about the gaze point of the second area. The preset parameter includes at least one of: a primary-secondary relationship of the first area and the second area, a matching degree between the image data of the first area and image data of a preset eye model, a matching degree between the image data of the second area and the image data of the preset eye model, confidence level based on the first area and confidence level based on the second area.

In step S206, the preset gaze point is determined according to the value of the preset parameter.

In an optional embodiment, if the first area is determined as a primary area for determining the information about the gaze point, the second area is an area which assists in determining the information about the gaze point. For example, in a gaze tracking process, the left eye is a primary eye and the right eye is a secondary eye. The primary eye for gaze tracking may be specified by a user or determined through a scoring mechanism. In addition, the primary eye is not necessarily the eye corresponding to the preset gaze point.

In another optional embodiment, the image data of the preset eye model is stored in the eye movement analysis device. The image data of the preset eye model may be, but is not limited to, a size of a pupil, a position of the center of the pupil and information of a gaze point and the like of the preset eye model. The information of the gaze point may include, but is not limited to, coordinates of the gaze point, a gaze direction, an angle between a line of sight and a reference axis and the like of the preset eye model. Optionally, if a matching degree between image data of the left eye and the image data of the preset eye model is greater than a preset threshold, the information about the gaze point corresponding to the left eye is determined to be the same as information about the gaze point corresponding to a left eye of the preset eye model. Similarly, the information about the gaze point of the right eye may be obtained by the above method.

In another optional embodiment, the preset gaze point may also be determined according to the confidence level obtained by processing the image data of the first area and the confidence level obtained by processing the image data of the second area, for example, a gaze point of an eye corresponding to an image with the highest confidence level is taken as the preset gaze point.

It is to be noted that a format of the data about the gaze point may be, but is not limited to, leftx, lefty, rightx, righty and recommendedleftorright. The leftx and lefty respectively represent an abscissa and an ordinate of the gaze point of the left eye, the rightx and righty respectively represent an abscissa and an ordinate of the gaze point of the right eye, and the recommendedleftorright represents the recommended gaze point, that is, the preset gaze point. For example, if the recommendedleftorright is 01, it indicates that the gaze point corresponding to the right eye is taken as the preset gaze point; if the recommendedleftorright is 10, it indicates that the gaze point corresponding to the left eye is taken as the preset gaze point.

In addition, it is to be noted that after the value of the preset parameter is obtained by the preceding method, the value of the preset parameter is processed to obtain the preset gaze point. After the preset gaze point is determined, the underlying processor sends the determined information about the gaze point to the terminal at an upper layer and the terminal determines the position information of the preset gaze point on the display screen. FIG. 3 is flowchart of an optional method for determining a gaze point based on an eye movement analysis device. As shown in FIG. 3, the terminal determines information about the position of the preset gaze point on the display screen according to the data about the gaze point, which specifically includes steps described below.

In step S302, the terminal acquires the preset gaze point in the data about the gaze point.

In step S304, the terminal acquires information about the gaze point of an eye corresponding to the preset gaze point.

In step S306, the terminal determines information about a position matched with the information about the gaze point on the display screen.

It is to be noted that the terminal may be, but is not limited to, an application program and a web page on the eye movement analysis device.

Optionally, after obtaining the data about the gaze point, the terminal parses the received data about the gaze point to obtain data that can be identified and processed by the terminal, determines the eye used as the preset gaze point according to the parsed data, and determines information about the position of the gaze point on the display screen according to the information about the gaze point of the determined eye. For example, if the eye corresponding to the preset gaze point is determined to be the left eye, the parameter recommendedleftorright=10 and the information about the gaze point corresponding to the left eye is extracted according to the recommendedleftorright. The information about the gaze point corresponding to the left eye includes, but is not limited to, a vector, coordinates and an angle of the gaze point of the left eye. After the information about the gaze point is determined, an object in the eye corresponding to the gaze point may be determined according to the information about the gaze point.

In an optional embodiment, after the information about the position of the preset gaze point on the display screen is determined, the terminal may further determine information about a position of a gaze point of the other eye on the display screen according to the preset gaze point by a specific method which includes steps described below.

In step S208a, when the preset gaze point is matched with the first area, a first image matched with the first area is acquired.

In step S210a, first position information of an object matched with the first image is acquired according to the first image. The first position information is information about a position of the object in a first space.

In step S212a, information about position matched with the information about the gaze point of the second area on the display screen is determined according to the first image and the first position information of the object.

Optionally, the preset gaze point is the gaze point corresponding to the left eye, and the terminal may obtain the information about the position of the gaze point of the left eye on the display screen and/or a gaze object in a view of the left eye, that is, the first image matched with the first area, according to the acquired data about the gaze point. Meanwhile, the terminal may further obtain the information about the position of the gaze object in the view of the left eye in the first space (i.e., an actual scenario) (the position information may be, but is not limited to, coordinates, a vector, an angle etc.), that is, the first position information. According to the first image and the first position information of the object, the terminal may estimate the information about the position of the gaze point of the second area (i.e., the right eye) on the display screen.

In another optional embodiment, the information about the position of the gaze point of the second area on the display screen may be further obtained according to the information about the gaze point corresponding to the second area in the data about the gaze point by a specific method which includes the steps described below.

In step S208b, when the preset gaze point is matched with the first area, the terminal acquires the information about the gaze point of the second area in the data about the gaze point.

In step S210b, the terminal determines information about a position matched with the information about the gaze point of the second area on the display screen according to the information about the gaze point of the second area.

It is to be noted that when the first area is the left eye and the second area is the right eye, after the preset gaze point is determined to be the gaze point corresponding to the left eye, the terminal may obtain the information about the position of the gaze point of the right eye on the display screen by the method for obtaining the information about the position of the gaze point of the left eye on the display screen. The specific method is the same as the method for obtaining information about the position of the gaze point of the left eye on the display screen, which is not repeated herein.

### Embodiment 2

According to the present embodiment, provided is a method embodiment for determining a gaze point based on an eye movement analysis device. FIG. 6 is a flowchart of a method for determining a gaze point based on an eye movement analysis device according to an embodiment of the present disclosure. As shown in FIG. 6, the method includes steps described below.

In step S602, data information about a first area of eyes and data information about a second area of the eyes are acquired.

It is to be noted that the eye movement analysis device in the present application includes, but is not limited to, a VR device, an AR device, an MR device and a smart terminal capable of gaze tracking. For example, the smart terminal is a mobile phone, a computer, a wearable device (such as 3D glasses) or the like. The first area of the eyes may be a left eye or a right eye. When the first area is the left eye, the second area may be the right eye. When the first area is the right eye, the second area may be the left eye. When the first area is the left eye, the second area is the right eye.

In addition, data information about the first area includes at least one of: image data of the first area, data collected by a sensor corresponding to the first area and a scan result of a raster scan performed on the first area; and data information about the second area includes at least one of: image data of the second area, data collected by a sensor corresponding to the second area and a scan result of a raster scan performed on the second area. The data collected by the sensor includes, but is not limited to, stress data, a capacitance value or a capacitance variance, a voltage value or the capacitance variance, a heat amount and the like.

In addition, it is to be further noted that the method for determining the gaze point based on the eye movement analysis device is described below by using an example in which the first area is the left eye and the second area is the right eye.

In an optional embodiment, in the eye movement analysis device, cameras, that is, a left camera and a right camera, are respectively disposed in areas corresponding to the left eye and the right eye. The left camera may acquire an image of the left eye and the right camera may acquire an image of the right eye so that image data of the left eye and image data of the right eye are obtained. The image data of the left eye and the image data of the right eye may include, but are not limited to, a central position of a pupil, a size of the pupil, a shape of the pupil, a position of a spot projected on the eyes and the like.

In another optional embodiment, one or more capacitive elements are respectively disposed in the areas corresponding to the left eye and the right eye in the eye movement analysis device. The eye movement analysis device may collect the capacitance variance of the one or more capacitive components and obtain data information about the left eye and data information about the right eye respectively according to the capacitance variance. For example, if the capacitance value of the one or more capacitive elements corresponding to the left eye becomes larger and the variance of the capacitance value exceeds a preset threshold, it indicates that the pupil expands or shrinks. Since the capacitance value changes when the eye rotates, a rotational state of the eye may be determined according to the capacitance value.

In addition, it is to be further noted that the eye movement analysis device may also determine the data information about the left eye or the right eye according to the scan result of the raster scan and/or a change of a magnetic field. In addition, the eye movement analysis device may acquire the data information about the eyes by a combination of the preceding various methods for acquiring the data information about the eyes.

In step S604, data about the gaze point is determined according to the data information about the first area and the data information about the second area.

The data about the gaze point in this embodiment includes: a preset gaze point, information about the gaze point corresponding to the first area and information about the gaze point corresponding to the second area.

It is to be noted that when the first area is the left eye and the second area is the right eye, information about the gaze point of the left eye may be, but is not limited to, coordinates of a gaze point of the left eye, a gaze direction of the left eye, an angle between a line of sight of the left eye and a reference axis and the like; similarly, information about the gaze point of the right eye may be, but is not limited to, coordinates of a gaze point of the right eye, a gaze direction of the right eye, an angle between a line of sight of the right eye and the reference axis and the like. The preceding preset gaze point is a recommended gaze point. For example, when the preset gaze point is the gaze point corresponding to the left eye, a terminal determines a position of the gaze point on a screen by using the information about the gaze point of the left eye. The preceding terminal may be, but is not limited to, a device for data transmission, a device for data processing and a customer premise equipment for display.

In addition, it is to be further noted that since the preset gaze point is an optimal gaze point obtained by comparing the information about the gaze point of the left eye with the information about the gaze point of the right eye, the position of the gaze point on the screen can be more accurately obtained by using the optimal gaze point.

In step S606, the data about the gaze point is sent to the terminal.

It is to be noted that the data information about the first area and the data information about the second area of the eyes are processed by an underlying processor of the eye movement analysis device. After the data information about the first area and the second area of the eyes is processed by the underlying processor, the data about the gaze point is sent to the terminal in manners such as a function call, a function callback, TCP/UDP communications, a pipeline, memory processing and file processing. After receiving the data about the gaze point, the terminal processes the data about the gaze point and accurately determines information about a position of the gaze point on a display screen or display interface of the terminal. The information about such position may be, but is not limited to, coordinates, an angle and a vector of the preset gaze point on the display screen, and coordinates, an angle and a vector of the preset gaze point in a virtual space or an actual space.

It may be known based on the solution defined by the preceding steps S602 to S606 that the data information about the first area of eyes and the data information about the second area of the eyes are acquired, the data about the gaze point is determined according to the data information about the first area and the data information about the second area and the data about the gaze point is sent to the terminal, where the data about the gaze point includes the preset gaze point, the information about the gaze point corresponding to the first area and the information about the gaze point corresponding to the second area.

It is easy to notice that the information about the gaze point of the first area and the information about the gaze point of the first area are both stored in the data about the gaze point and the data about the gaze point is sent from an underlying program to an application program, that is, the application program may acquire the information about the gaze point of the two eyes. Compared with obtaining information about the gaze point of only one eye in the existing art, the present application may accurately determine the position of the gaze point on the screen according to the information about the gaze point of the two eyes. In addition, the recommended gaze point of the eyes may be determined according to the preset gaze point, and a more accurate position of the gaze point of the eyes on the screen may be obtained according to the recommended gaze point, thereby further ensuring the accuracy of the position of the gaze point on the screen.

It may be known from the above description that the present application may achieve the purpose of accurately determining the position of the gaze point on the screen when the eyes have large parallax, thereby achieving the technical effect of ensuring the accuracy of the position of the gaze point on the screen and solving the problem that an eye movement analysis device cannot accurately acquire the position of the gaze point on the screen when the eyes have large parallax.

In an optional embodiment, the step in which the data about the gaze point is determined according to the data information about the first area and the second area specifically includes steps described below.

In step S60, the data information about the first area and the data information about the second area are processed to obtain the information about the gaze point of the first area and the information about the gaze point of the second area.

In step S62, a value of a preset parameter is determined according to the information about the gaze point of the first area and the information about the gaze point of the second area. The preset parameter includes at least one of: a primary-secondary relationship of the first area and the second area, a matching degree between the image data of the first area and image data of a preset eye model, a matching degree between the image data of the second area and the image data of the preset eye model, confidence level based on the first area and confidence level based on the second area.

In step S64, the preset gaze point is determined according to the value of the preset parameter.

In an optional embodiment, if the first area is determines as a primary area for determining the information about the gaze point, the second area is an area which assists in determining the information about the gaze point. For example, in a gaze tracking process, the left eye is a primary eye and the right eye is a secondary eye. The primary eye used for gaze tracking may be specified by a user or determined through a scoring mechanism. In addition, the primary eye is not necessarily the eye corresponding to the preset gaze point.

In another optional embodiment, the image data of the preset eye model is stored in the eye movement analysis device. The image data of the preset eye model may be, but is not limited to, a size of a pupil, a position of the center of the pupil and information of a gaze point and the like of the preset eye model. The information of the gaze point may include, but is not limited to, coordinates of the gaze point, a gaze direction, an angle between a line of sight and a reference axis and the like of the preset eye model. Optionally, if a matching degree between image data of the left eye and the image data of the preset eye model is greater than a preset threshold, the information about the gaze point corresponding to the left eye is determined to be the same as information about the gaze point corresponding to a left eye of the preset eye model. Similarly, the information about the gaze point of the right eye may be obtained by the above method.

In another optional embodiment, the preset gaze point may also be determined according to the confidence level obtained by processing the image data of the first area and the confidence level obtained by processing the image data of the second area, for example, a gaze point of an eye corresponding to an image with the highest confidence level is taken as the preset gaze point.

It is to be noted that a format of the data about the gaze point may be, but is not limited to, leftx, lefty, rightx, righty and recommendedleftorright. The leftx and lefty respectively represent an abscissa and an ordinate of the gaze point of the left eye, the rightx and righty respectively represent an abscissa and an ordinate of the gaze point of the right eye, and the recommendedleftorright represents the recommended gaze point, that is, the preset gaze point. For example, if the recommendedleftorright is 01, it indicates that the gaze point corresponding to the right eye is taken as the preset gaze point; if the recommendedleftorright is 10, it indicates that the gaze point corresponding to the left eye is taken as the preset gaze point.

### Embodiment 3

According to the present embodiment, provided is a method embodiment for determining a gaze point based on an eye movement analysis device. FIG. 7 is a flowchart of a method for determining a gaze point based on an eye movement analysis device according to an embodiment of the present disclosure. As shown in FIG. 7, the method includes steps described below.

In step S702, data about the gaze point is received.

The data about the gaze point in this embodiment includes: a preset gaze point, information about the gaze point corresponding to a first area of eyes and information about the gaze point corresponding to a second area of the eyes.

In step S704, information about a position of the preset gaze point on a display screen is determined according to the data about the gaze point.

It is to be noted that step S702 and step S704 may be executed by a terminal. The terminal may be, but is not limited to, an application program and a web page on the eye movement analysis device.

It is to be noted that data information about the first area includes at least one of: image data of the first area, data collected by a sensor corresponding to the first area or a scan result of a raster scan performed on the first area; and data information about the second area includes at least one of: image data of the second area, data collected by a sensor corresponding to the second area or a scan result of a raster scan performed on the second area.

It may be known from the above description that the data about the gaze point is received and the information about the position of the preset gaze point on the display screen is determined according to the data about the gaze point. The data about the gaze point in this embodiment includes: the preset gaze point, the information about the gaze point corresponding to the first area of the eyes and the information about the gaze point corresponding to the second area of the eyes.

It is easy to notice that the information about the gaze point of the first area and the information about the gaze point of the first area are both stored in the data about the gaze point and the data about the gaze point is sent from an underlying program to an application program, that is, the application program may acquire the information about the gaze point of the two eyes. Compared with acquiring information about the gaze point of only one eye in the existing art, the present application may accurately determine a position of a gaze point on a screen according to the information about the gaze point of the two eyes. In addition, a recommended gaze point of the eyes may be determined according to the preset gaze point, and a more accurate position of the gaze point of the eyes on the screen may be obtained according to the recommended gaze point, thereby further ensuring the accuracy of the position of the gaze point on the screen.

It may be known from the above description that the present application may achieve the purpose of accurately determining the position of the gaze point on the screen when the eyes have large parallax, thereby achieving the technical effect of ensuring the accuracy of the position of the gaze point on the screen and solving the problem that an eye movement analysis device cannot accurately acquire the position of the gaze point on the screen when the eyes have large parallax.

In an optional embodiment, the step in which the information about the position of the preset gaze point on the display screen is determined according to the data about the gaze point specifically includes steps described below.

In step S7040, the preset gaze point in the data about the gaze point is acquired.

In step S7042, information about the gaze point of an eye corresponding to the preset gaze point is acquired.

In step S7044, information about a position matched with the information about the gaze point on the display screen is determined.

Optionally, after obtaining the data about the gaze point, the terminal parses the received data about the gaze point to obtain data than can be identified and processed by the terminal, determines the eye used as the preset gaze point according to the parsed data, and determines the information about the position of the gaze point on the display screen according to the information about the gaze point of the determined eye. For example, if the eye corresponding to the preset gaze point is determined to be a left eye, a parameter recommendedleftorright=10 and information about the gaze point corresponding to the left eye is extracted according to the recommendedleftorright. The information about the gaze point corresponding to the left eye includes, but is not limited to, a vector, coordinates and an angle of a gaze point of the left eye. After the information about the gaze point is determined, an object in the eye corresponding to the gaze point may be determined according to the information about the gaze point.

In an optional embodiment, after the information about the position matched with the information about the gaze point on the display screen is determined, the method for determining the gaze point further includes steps described below.

In step S80, when the preset gaze point is matched with the first area, a first image matched with the first area is acquired.

In step S82, first position information of an object matched with the first image is acquired according to the first image. The first position information is information about the position of the object in a first space.

In step S84, information about a position on the display screen matched with the information about the gaze point of the second area is determined according to the first image and the first position information of the object.

Optionally, the preset gaze point is a gaze point corresponding to the left eye, and the terminal may obtain, according to the acquired data about the gaze point, the information about the position of the gaze point of the left eye on the display screen and/or a gaze object in a view of the left eye, that is, the first image matched with the first area. Meanwhile, the terminal may further obtain information about the position (which may be, but is not limited to, coordinates, a vector, an angle etc.) of the gaze object in the view of the left eye in the first space (i.e., an actual scenario), that is, the first position information. According to the first image and the first position information of the object, the terminal may estimate information about the position of a gaze point of the second area (i.e., a right eye) on the display screen.

In another optional embodiment, the information about the position of the gaze point of the second area on the display screen may be further obtained according to the information about the gaze point corresponding to the second area in the data about the gaze point by a specific method which includes steps described below.

In step S90, when the preset gaze point is matched with the first area, the terminal acquires the information about the gaze point of the second area in the data about the gaze point.

In step S92, the terminal determines information about the position matched with the information about the gaze point of the second area on the display screen according to the information about the gaze point of the second area.

It is to be noted that when the first area is the left eye and the second area is the right eye, after the preset gaze point is determined to be the gaze point corresponding to the left eye, the terminal may obtain information about the position of the gaze point of the right eye on the display screen by the method for obtaining the information about the position of the gaze point of the left eye on the display screen. The specific method is the same as the method for obtaining the information about the position of the gaze point of the left eye on the display screen, which is not repeated herein.

### Embodiment 4

An embodiment of the present disclosure further provides an eye movement analysis device configured to execute the method for determining the gaze point based on the eye movement analysis device provided in embodiment 1. FIG. 4 is a structural diagram of an eye movement analysis device. As shown in FIG. 4, the eye movement analysis device includes a collection unit 401 and a processing unit 403.

The collection unit 401 is configured to acquire data information about a first area of eyes and data information about a second area of eyes determine data about the gaze point according to the data information about the first area and the data information about the second area, where the data about the gaze point includes: a preset gaze point, information about a gaze point corresponding to the first area and information about a gaze point corresponding to the second area and send the data about the gaze point. The processing unit 403 is connected to the collection unit and configured to receive the data about the gaze point, and determine information about a position of the preset gaze point on a display screen according to the data about the gaze point by acquiring the preset gaze point in the data about the gaze point, acquiring information about a gaze point of an eye corresponding to the preset gaze point, and determining information about a position matched with the information about the gaze point on the display screen.

It is to be noted that the collection unit is a device for collecting data which may be, but is not limited to, a camera, a mobile phone, a computer, a wearable device and the like. The processing unit is a device for processing data which may be, but is not limited to, a device for data transmission, a device for data processing and a client for display. In addition, data information about the first area includes at least one of: image data of the first area, data collected by a sensor corresponding to the first area and a scan result of a raster scan performed on the first area; and data information about the second area includes at least one of: image data of the second area, data collected by a sensor corresponding to the second area and a scan result of a raster scan performed on the second area.

It may be known from the above description that the collection unit acquires the data information about the first area of the eyes and the data information about the second area of the eyes, determines the data about the gaze point according to the data information about the first area and the data information about the second area, and send the data about the gaze point; and the processing unit connected to the collection unit receives the data about the gaze point and determines the information about the position of the preset gaze point on the display screen according to the data about the gaze point by acquiring the preset gaze point in the data about the gaze point, acquiring the information about the gaze point of the eye corresponding to the preset gaze point, and determining the information about the position matched with the information about the gaze point on the display screen. The data about the gaze point includes: the preset gaze point, the information about the gaze point corresponding to the first area and the information about the gaze point corresponding to the second area.

It is easy to notice that the information about the gaze point of the first area and the information about the gaze point of the first area are both stored in the data about the gaze point and the data about the gaze point is sent from an underlying program to an application program, that is, the application program may acquire the information about the gaze point of the two eyes. Compared with acquiring information about the gaze point of only one eye in the existing art, the present application may accurately determine a position of a gaze point on a screen according to the information about the gaze point of the two eyes. In addition, a recommended gaze point of the eyes may be determined according to the preset gaze point, and a more accurate position of the gaze point of the eyes on the screen may be obtained according to the recommended gaze point, thereby further ensuring the accuracy of the position of the gaze point on the screen.

It may be known from the above description that the present application may achieve the purpose of accurately determining the position of the gaze point on the screen when the eyes have large parallax, thereby achieving the technical effect of ensuring the accuracy of the position of the gaze point on the screen and solving the problem that an eye movement analysis device cannot accurately acquire the position of the gaze point on the screen when the eyes have large parallax.

In an optional embodiment, the collection unit is further configured to process the data information about the first area and the data information about the second area to obtain the information about the gaze point of the first area and the information about the gaze point of the second area; determine, according to the information about the gaze point of the first area and the information about the gaze point of the second area, a value of a preset parameter; and determine the preset gaze point according to the value of the preset parameter. The preset parameter includes at least one of: a primary-secondary relationship of the first area and the second area, a matching degree between the image data of the first area and image data of a preset eye model, a matching degree between the image data of the second area and the image data of the preset eye model, confidence level based on the first area or confidence level based on the second area.

In an optional embodiment, the processing unit is further configured to acquire a first image matched with the first area when the preset gaze point is matched with the first area; acquire first position information of an object matched with the first image according to the first image, where the first position information is information about a position of the object in a first space; and determine information about a position matched with the information about the gaze point of the second area on the display screen according to the first image and the first position information of the object.

### Embodiment 5

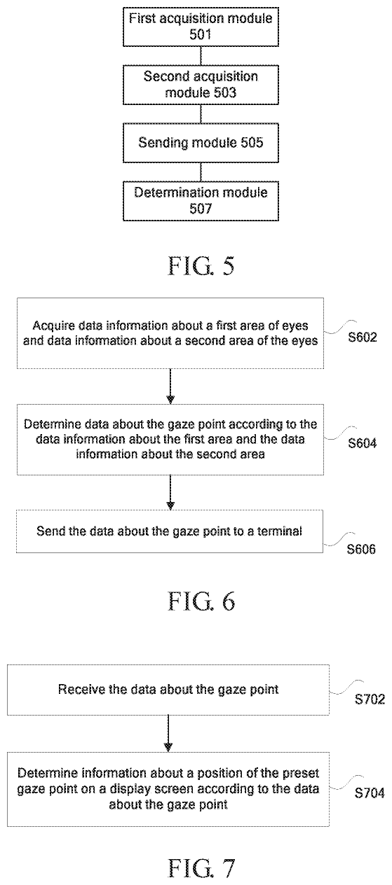

According to the present embodiment, provided is an apparatus embodiment for determining a gaze point based on an eye movement analysis device. It is to be noted that the apparatus for determining the gaze point based on the eye movement analysis device may be configured to execute the method for determining the gaze point based on the eye movement analysis device provided in the embodiments of the present disclosure. The apparatus for determining the gaze point based on the eye movement analysis device includes at least one processor and at least one memory for storing a program unit. The program unit is executed by the at least one processor and the program unit includes a first acquisition module, a second acquisition module, a sending module and a determination module. FIG. 5 is a structural diagram of a device for determining a gaze point based on an eye movement analysis device according to an embodiment of the present disclosure. As shown in FIG. 5, the device includes a first acquisition module 501, a second acquisition module 503, a sending module 505 and a determination module 507.

The first acquisition module 501 is configured to acquire data information about a first area of eyes and data information about a second area of eyes. The second acquisition module 503 is configured to determine data about the gaze point according to the data information about the first area and the data information about the second area. The data about the gaze point includes: a preset gaze point, information about the gaze point corresponding to the first area and information about the gaze point corresponding to the second area. The sending module 505 is configured to send the data about the gaze point to a terminal. The determination module 507 is configured to enable the terminal to receive the data about the gaze point and determine information about a position of the preset gaze point on a display screen according to the data about the gaze point.

It is to be noted that data information about the first area includes at least one of: image data of the first area, data collected by a sensor corresponding to the first area and a scan result of a raster scan performed on the first area; and data information about the second area includes at least one of: image data of the second area, data collected by a sensor corresponding to the second area and a scan result of a raster scan performed on the second area.

In addition, it is to be further noted that the first acquisition module 501, the second acquisition module 503, the sending module 505 and the determination module 507 correspond to steps S102 to S108 in embodiment 1, and the four modules have the same examples and application scenarios in which the corresponding steps are implemented, but are not limited to what has been disclosed in embodiment 1.

It is to be noted here that the first acquisition module 501, the second acquisition module 503, the sending module 505 and the determination module 507 may be executed in the terminal as part of the device and the functions of the four modules may be implemented by a processor in the terminal. The terminal may also be a terminal device such as a smart phone (such as an Android phone and an iOS phone), a tablet computer, a handheld computer, a mobile Internet device (MID) and a PAD.

In an optional embodiment, the second acquisition module includes a fifth acquisition module, a first determination module and a second determination module. The fifth acquisition module is configured to process the data information about the first area and the second area to obtain the information about the gaze point of the first area and the information about the gaze point of the second area. The first determination module is configured to determine, according to the information about the gaze point of the first area and the information about the gaze point of the second area, a value of a preset parameter. The preset parameter includes at least one of: a primary-secondary relationship of the first area and the second area, a matching degree between the image data of the first area and image data of a preset eye model, a matching degree between the image data of the second area and the image data of the preset eye model, confidence level based on the first area or confidence level based on the second area. The second determination module is configured to determine the preset gaze point according to the value of the preset parameter.

It is to be noted that the fifth acquisition module, the first determination module and the second determination module correspond to steps S202 to S206 in embodiment 1, and the three modules have the same examples and application scenarios in which the corresponding steps are implemented, but are not limited to what has been disclosed in embodiment 1.

It is to be noted here that the fifth acquisition module, the first determination module and the second determination module may be executed in the terminal as part of the apparatus and the functions of the three modules may be implemented by the processor in the terminal.

In an optional embodiment, the determination module includes a third acquisition module, a fourth acquisition module and a display module. The third acquisition module is configured to enable the terminal to acquire the preset gaze point in the data about the gaze point. The fourth acquisition module is configured to enable the terminal to acquire information about the gaze point of an eye corresponding to the preset gaze point. The display module is configured to enable the terminal to determine information about a position matched with the information about the gaze point on the display screen.

It is to be noted that the third acquisition module, the fourth acquisition module and the display module correspond to steps S302 to S306 in embodiment 1, and the three modules have the same examples and application scenarios in which the corresponding steps are implemented, but are not limited to what has been disclosed in embodiment 1.

It is to be noted here that the third acquisition module, the fourth acquisition module and the display module may be executed in the terminal as part of the device and the functions of the three modules may be implemented by the processor in the terminal.

In an optional embodiment, the device for determining the gaze point based on the eye movement analysis device further includes a sixth acquisition module, a seventh acquisition module and a third determination module. The sixth acquisition module is configured to enable the terminal to acquire a first image matched with the first area when the preset gaze point is matched with the first area. The seventh acquisition module is configured to enable the terminal to acquire first position information of an object matched with the first image according to the first image. The first position information is information about the position of the object in a first space. The third determination module is configured to enable the terminal to determine information about a position matched with the information about the gaze point of the second area on the display screen according to the first image and the first position information of the object.

It is to be noted that the sixth acquisition module, the seventh acquisition module and the third determination module correspond to steps S208a to S212a in embodiment 1, and the three modules have the same examples and application scenarios in which the corresponding steps are implemented, but are not limited to what has been disclosed in embodiment 1.

It is to be noted here that the sixth acquisition module, the seventh acquisition module and the third determination module may be executed in the terminal as part of the device and the functions of the three modules may be implemented by the processor in the terminal.

In an optional embodiment, the device for determining the gaze point based on the eye movement analysis device further includes an eighth acquisition module and a fourth determination module. The eighth acquisition module is configured to enable the terminal to acquire the information about the gaze point of the second area in the data about the gaze point when the preset gaze point is matched with the first area. The fourth determination module is configured to enable the terminal to determine information about the position matched with the information about the gaze point of the second area on the display screen according to the information about the gaze point of the second area.

It is to be noted that the eighth acquisition module and the fourth determination module correspond to steps S208b to S210b in embodiment 1, and the two modules have the same examples and application scenarios in which the corresponding steps are implemented, but are not limited to what has been disclosed in embodiment 1.

It is to be noted here that the eighth acquisition module and the fourth determination module may be executed in the terminal as part of the device and the functions of the two modules may be implemented by the processor in the terminal.

According to the embodiments of the present disclosure, further provided is an apparatus embodiment for determining a gaze point based on an eye movement analysis device.

The apparatus for determining the gaze point based on the eye movement analysis device includes an acquisition module, a determination module and a sending module. The acquisition module is configured to acquire data information about a first area and a second area of eyes. The determination module is configured to determine data about the gaze point according to the data information about the first area and the data information about the second area. The data about the gaze point includes: a preset gaze point, information about the gaze point corresponding to the first area and information about the gaze point corresponding to the second area. The sending module is configured to send the data about the gaze point to a terminal.

In addition, it is to be further noted that the acquisition module, the determination module and the sending module correspond to steps S602 to S606 in embodiment 1, and the three modules have the same examples and application scenarios in which the corresponding steps are implemented, but are not limited to what has been disclosed in embodiment 1.

It is to be noted here that the acquisition module, the determination module and the sending module may be executed in the terminal as part of the device and the functions of the three modules may be implemented by a processor in the terminal.

According to the embodiments of the present disclosure, further provided is a device embodiment for determining a gaze point based on an eye movement analysis device.

The apparatus for determining the gaze point based on the eye movement analysis device includes a receiving module and a determination module. The receiving module is configured to enable a terminal to receive data about the gaze point. The data about the gaze point includes: a preset gaze point, information about the gaze point corresponding to a first area of eyes and information about the gaze point corresponding to a second area of the eyes. The determination module is configured to enable the terminal to determine information about a position of the preset gaze point on a display screen according to the data about the gaze point.

In addition, it is to be further noted that the receiving module and the determination module correspond to steps S702 to S704 in embodiment 1, and the two modules have the same examples and application scenarios in which the corresponding steps are implemented, but are not limited to what has been disclosed in embodiment 1.

It is to be noted here that the receiving module and the determination module may be executed in the terminal as part of the device and the functions of the two modules may be implemented by a processor in the terminal.

### Embodiment 6

According to another aspect of the embodiments of the present disclosure, further provided is a storage medium. The storage medium includes stored programs which execute the method for determining the gaze point based on the eye movement analysis device in embodiment 1.

The various functional modules provided by the embodiments of the present application may be executed in the eye movement analysis device or a similar computing apparatus, and may also be stored as part of the storage medium.

Optionally, in this embodiment, the preceding storage medium stores computer programs, which, when executed, is configured to execute a data processing method.

Optional, in this embodiment, the storage medium is configured to store program codes for executing the following steps: acquiring data information about a first area of eyes and data information about a second area of eyes determining data about the gaze point according to the data information about the first area and the data information about the second area, where the data about the gaze point includes: a preset gaze point, information about the gaze point corresponding to the first area and information about the gaze point corresponding to the second area sending the data about the gaze point to a terminal; and receiving, by the terminal, the data about the gaze point and determining information about a position of the preset gaze point on a display screen according to the data about the gaze point.

Optional, in this embodiment, the storage medium is configured to store program codes for executing the following steps: acquiring data information about a first area of eyes and data information about a second area of eyes; determining data about the gaze point according to the data information about the first area and the data information about the second area, where the data about the gaze point includes: a preset gaze point, information about the gaze point corresponding to the first area and information about the gaze point corresponding to the second area; and sending the data about the gaze point to a terminal.

Optional, in this embodiment, the storage medium is configured to store program codes for executing the following steps: receiving, by a terminal, data about the gaze point, where the data about the gaze point includes: a preset gaze point, information about the gaze point corresponding to a first area of eyes and information about the gaze point corresponding to a second area of the eyes; and determining, by the terminal, information about a position of the preset gaze point on a display screen according to the data about the gaze point.

Optionally, in this embodiment, the storage medium may be further configured to store program codes for executing the steps of the various preferred or optional methods provided by the method for controlling an air-conditioner.

### Embodiment 7

According to another aspect of the embodiments of the present disclosure, further provided is a processor. The processor is configured to execute programs, which, when executed, execute the method for determining the gaze point based on the eye movement analysis device in embodiment 1.

In this embodiment, the processor may call execution programs of the method for determining the gaze point based on the eye movement analysis device.

Optional, in this embodiment, the processor may be configured to execute the following steps: acquiring data information about a first area of eyes and data information about a second area of eyes; determining data about the gaze point according to the data information about the first area and the data information about the second area, where the data about the gaze point includes: a preset gaze point, information about the gaze point corresponding to the first area and information about the gaze point corresponding to the second area sending the data about the gaze point to a terminal.

Optional, in this embodiment, the processor may be configured to execute the following steps: acquiring data information about a first area of eyes and data information about a second area of eyes; determining data about the gaze point according to the data information about the first area and the data information about the second area, where the data about the gaze point includes: a preset gaze point, information about the gaze point corresponding to the first area and information about the gaze point corresponding to the second area; and sending the data about the gaze point to a terminal.

Optional, in this embodiment, the processor may be configured to execute the following steps: a terminal is enabled to receive data about the gaze point, where the data about the gaze point includes: a preset gaze point, information about the gaze point corresponding to a first area of eyes and information about the gaze point corresponding to a second area of the eyes; and the terminal is enabled to determine information about a position of the preset gaze point on a display screen according to the data about the gaze point.

The processor may execute the software programs and modules stored in a memory to implement various functional applications and data processing, that is, to implement the method for determining the gaze point based on the eye movement analysis device described above.

It may be understood by those skilled in the art that all or part of the steps in the various methods in the embodiments described above may be implemented by related hardware of an eye movement analysis device according to an indication of the programs which may be stored in a storage medium readable by the eye movement analysis device. The storage medium may include a flash disk, a rad-only memory (ROM), a random access memory (RAM), a magnetic disk, an optical disk or the like.

The method and device for determining the gaze point based on the eye movement analysis device according to the present disclosure are described by way of examples with reference to the drawings. However, it should be understood by those skilled in the art that for the method and device for determining the gaze point based on the eye movement analysis device provided by the present disclosure, various improvements may also be made without departing from the content of the present disclosure. Therefore, the scope of protection of the present disclosure should be determined by the appended claims.

The serial numbers of the embodiments described above of the present disclosure are merely for ease of description and do not indicate superiority and inferiority of the embodiments.

In the embodiments described above of the present disclosure, the description of each embodiment has its own emphasis. For a part not described in detail in one embodiment, reference may be made to a related description of other embodiments.

It should be understood that the technical content disclosed in the embodiments of the present application may be implemented in other ways. The apparatus embodiments described above are merely exemplary. For example, the unit classification may be a logical function classification, and, in practice, the unit classification may be implemented in other ways. For example, multiple units or components may be combined or may be integrated into another system, or some features may be omitted or not executed. Additionally, the presented or discussed mutual coupling, direct coupling or communication connections may be indirect coupling or communication connections via interfaces, units or modules, or may be electrical or in other forms.

The units described as separate components may or may not be physically separated. Components presented as units may or may not be physical units, i.e., may be located in one place or may be distributed on multiple units. Part or all of these units may be selected according to practical requirements to achieve the objects of the solutions in the embodiments of the present disclosure.

Additionally, various functional units in each embodiment of the present disclosure may be integrated into one processing unit, or each unit may be physically present separately, or two or more units may be integrated into one unit. The integrated unit may be implemented by hardware or a software functional unit.

The integrated unit may be stored in a computer-readable storage medium if implemented in the form of the software functional unit and sold or used as an independent product. Based on this understanding, the solutions provided by the present disclosure substantially or the part contributing to the existing art or all or part of the solutions may be embodied in the form of a software product. The software product is stored on a storage medium and includes several instructions for enabling a computer device (which may be a personal computer, a server or a network device) to execute all or part of the steps in the methods provided by the embodiments of the present disclosure. The preceding storage medium includes: a USB flash drive, a ROM, a RAM, a mobile hard disk, a magnetic disk, an optical disk or another medium capable of storing program codes.

The above are merely preferred implementation modes of the present disclosure. It is to be noted that for those skilled in the art, a number of improvements and modifications may be made without departing from the principle of the present disclosure, and these improvements and modifications are within the scope of the present disclosure.

### INDUSTRIAL APPLICABILITY

In the technical solutions provided by the embodiments of the present application, by performing data transmission with a gaze point interface, the data information about the first area of the eyes and the data information about the second area of the eyes are acquired, the data about the gaze point is determined according to the data information about the first area and the data information about the second area, and the data about the gaze point is sent to the terminal, where the data about the gaze point includes: the preset gaze point, the information about the gaze point corresponding to the first area and the information about the gaze point corresponding to the second area so that the present application achieves the purpose of accurately determining the position of the gaze point on the screen when the eyes have large parallax, thereby achieving the technical effect of ensuring the accuracy of the position of the gaze point on the screen and solving the problem that the eye movement analysis device cannot accurately acquire the position of the gaze point on the screen when the eyes have large parallax.

1. A method for determining a gaze point based on an eye movement analysis device, comprising:
acquiring data information about a first area of eyes and data information about a second area of the eyes;
determining data about the gaze point according to the data information about the first area and the data information about the second area, wherein the data about the gaze point comprises: a preset gaze point, information about the gaze point corresponding to the first area and information about the gaze point corresponding to the second area;
sending the data about the gaze point to a terminal; and
receiving, by the terminal, the data about the gaze point and determining, according to the data about the gaze point, information about a position of the preset gaze point on a display screen.

2. The method of claim 1, wherein the data information about the first area comprises at least one of: image data of the first area, data collected by a sensor corresponding to the first area and a scan result of a raster scan performed on the first area; and the data information about the second area comprises at least one of: image data of the second area, data collected by a sensor corresponding to the second area or a scan result of a raster scan performed on the second area.

3. The method of claim 2, wherein the determining data about the gaze point according to the data information about the first area and the data information about the second area comprises:
processing the data information about the first area and the data information about the second area to obtain information about the gaze point of the first area and information about the gaze point of the second area;
determining, according to the information about the gaze point of the first area and the information about the gaze point of the second area, a value of a preset parameter, wherein the preset parameter comprises at least one of: a primary-secondary relationship of the first area and the second area, a matching degree between the image data of the first area and image data of a preset eye model, a matching degree between the image data of the second area and the image data of the preset eye model, confidence level based on the first area and confidence level based on the second area; and
determining the preset gaze point according to the value of the preset parameter.

4. The method of claim 1, wherein the determining, according to the data about the gaze point, information about a position of the preset gaze point on a display screen comprises:
acquiring, by the terminal, the preset gaze point in the data about the gaze point;
acquiring, by the terminal, information about the gaze point of an eye corresponding to the preset gaze point; and
determining, by the terminal, the information about a position matched with the information about the gaze point on the display screen.

5. The method of claim 4, wherein after the determining, according to the data about the gaze point, information about a position of the preset gaze point on a display screen, the method further comprises:
when the preset gaze point is matched with the first area, acquiring, by the terminal, a first image matched with the first area;
acquiring, by the terminal, first position information of an object matched with the first image according to the first image, wherein the first position information is information about the position of the object in a first space; and
determining, by the terminal, information about a position matched with the information about the gaze point of the second area on the display screen according to the first image and the first position information of the object.

6. A method for determining a gaze point based on an eye movement analysis device, comprising:
acquiring data information about a first area of eyes and data information about a second area of the eyes;
determining data about the gaze point according to the data information about the first area and the data information about the second area, wherein the data about the gaze point comprises: a preset gaze point, information about the gaze point corresponding to the first area and information about the gaze point corresponding to the second area; and
sending the data about the gaze point to a terminal.

7. The method of claim 6, wherein the data information about the first area comprises at least one of: image data of the first area, data collected by a sensor corresponding to the first area and a scan result of a raster scan performed on the first area; and the data information about the second area comprises at least one of: image data of the second area, data collected by a sensor corresponding to the second area and a scan result of a raster scan performed on the second area.

8. The method of claim 7, wherein the determining data about the gaze point according to the data information about the first area and the data information about the second area comprises:
processing the data information about the first area and the data information about the second area to obtain information about the gaze point of the first area and information about the gaze point of the second area;
determining, according to the information about the gaze point of the first area and the information about the gaze point of the second area, a value of a preset parameter, wherein the preset parameter comprises at least one of: a primary-secondary relationship of the first area and the second area, a matching degree between the image data of the first area and image data of a preset eye model, a matching degree between the image data of the second area and the image data of the preset eye model, confidence level based on the first area and confidence level based on the second area; and
determining the preset gaze point according to the value of the preset parameter.

9. A method for determining a gaze point based on an eye movement analysis device, comprising:
receiving, by a terminal, data about the gaze point, wherein the data about the gaze point comprises: a preset gaze point, information about the gaze point corresponding to a first area of eyes and information about the gaze point corresponding to a second area of the eyes; and
determining, according to the data about the gaze point, information about a position of the preset gaze point on a display screen by the terminal.

10. The method of claim 9, wherein the determining, according to the data about the gaze point, information about a position of the preset gaze point on a display screen by the terminal comprises:
acquiring the preset gaze point in the data about the gaze point;
acquiring information about the gaze point of an eye corresponding to the preset gaze point; and
determining information about a position matched with the information about the gaze point on the display screen.

11. The method of claim 10, wherein after the determining information about a position matched with the information about the gaze point on the display screen, the method further comprises:
when the preset gaze point is matched with the first area, acquiring a first image matched with the first area;
acquiring first position information of an object matched with the first image according to the first image, wherein the first position information is information about a position of the object in a first space; and
determining, according to the first image and the first position information of the object, the information about the position matched with the information about the gaze point of the second area on the display screen.

12. An eye movement analysis device, comprising at least one processor and at least one memory for storing a program unit that when executed by the at least one processor cause the at least one processor to perform functions of the following units:
a collection unit, configured to acquire data information about a first area of eyes and data information about a second area of the eyes; determine data about a gaze point according to the data information about the first area and the data information about the second area, wherein the data about the gaze point comprises: a preset gaze point, information about the gaze point corresponding to the first area and information about the gaze point corresponding to the second area; and send the data about the gaze point; and
a processing unit connected to the collection unit, configured to receive the data about the gaze point, and determine information about a position of the preset gaze point on a display screen according to the data about the gaze point by the followings: acquiring the preset gaze point in the data about the gaze point, acquiring information about the gaze point of an eye corresponding to the preset gaze point, and determining information about a position matched with the information about the gaze point on the display screen.

13. An apparatus for determining a gaze point based on an eye movement analysis device, comprising at least one processor and at least one memory for storing a program unit that when executed by the at least one processor cause the at least one processor to perform functions of the following modules to implement the method according to claim 1:
a first acquisition module, configured to acquire data information about a first area of eyes and data information about a second area of the eyes;
a second acquisition module, configured to determine data about the gaze point according to the data information about the first area and the data information about the second area, wherein the data about the gaze point comprises: a preset gaze point, information about the gaze point corresponding to the first area and information about the gaze point corresponding to the second area;
a sending module, configured to send the data about the gaze point to a terminal; and
a determination module, configured to enable the terminal to receive the data about the gaze point and determine information about a position of the preset gaze point on a display screen according to the data about the gaze point.

14. The apparatus of claim 13, wherein the data information about the first area comprises at least one of: image data of the first area, data collected by a sensor corresponding to the first area and a scan result of a raster scan performed on the first area; and the data information about the second area comprises at least one of: image data of the second area, data collected by a sensor corresponding to the second area and a scan result of a raster scan performed on the second area.

15. The apparatus of claim 14, wherein the second acquisition module comprises:
a fifth acquisition module, configured to process the data information about the first area and the data information about the second area to obtain the information about the gaze point of the first area and the information about the gaze point of the second area;
a first determination module, configured to determine, according to the information about the gaze point of the first area and the information about the gaze point of the second area, a value of a preset parameter, wherein the preset parameter comprises at least one of: a primary-secondary relationship of the first area and the second area, a matching degree between the image data of the first area and image data of a preset eye model, a matching degree between the image data of the second area and the image data of the preset eye model, confidence level based on the first area and confidence level based on the second area; and
a second determination module, configured to determine the preset gaze point according to the value of the preset parameter.

16. The apparatus of claim 13, wherein the determination module comprises:
a third acquisition module, configured to enable the terminal to acquire the preset gaze point in the data about the gaze point;
a fourth acquisition module, configured to enable the terminal to acquire information about the gaze point of an eye corresponding to the preset gaze point; and
a display module, configured to enable the terminal to determine information about a position matched with the information about the gaze point on the display screen.

17. The apparatus of claim 16, further comprising:
a sixth acquisition module, configured to enable the terminal to acquire a first image matched with the first area when the preset gaze point is matched with the first area;
a seventh acquisition module, configured to enable the terminal to acquire first position information of an object matched with the first image according to the first image, wherein the first position information is information about a position of the object in a first space; and
a third determination module, configured to enable the terminal to determine, according to the first image and the first position information of the object, information about a position matched with the information about the gaze point of the second area on the display screen.

18. An apparatus for determining a gaze point based on an eye movement analysis device, comprising at least one processor and at least one memory for storing a program unit that when executed by the at least one processor cause the at least one processor to perform functions of the following modules to implement the method according to claim 6:
an acquisition module, configured to acquire data information about a first area of eyes and data information about a second area of the eyes;
a determination module, configured to determine data about the gaze point according to the data information about the first area and data information about the second area, wherein the data about the gaze point comprises: a preset gaze point, information about the gaze point corresponding to the first area and information about the gaze point corresponding to the second area; and
a sending module, configured to send the data about the gaze point to a terminal.

19. An apparatus for determining a gaze point based on an eye movement analysis device, comprising at least one processor and at least one memory for storing a program unit that when executed by the at least one processor cause the at least one processor to perform functions of the following modules to implement the method according to claim 9:
a receiving module, configured to enable a terminal to receive data about the gaze point, wherein the data about the gaze point comprises: a preset gaze point, information about the gaze point corresponding to a first area of eyes and information about the gaze point corresponding to a second area of the eyes; and
a determination module, configured to enable the terminal to determine, according to the data about the gaze point, information about a position of the preset gaze point on a display screen.

20. A non-transitory storage medium, comprising stored programs, wherein, when executed, the programs execute the method for determining the gaze point based on the eye movement analysis device of claim 1.

21. A processor, configured to execute programs, wherein, when executed, the programs execute the method for determining the gaze point based on the eye movement analysis device of claim 1.
